(19) United States
(12) Patent Application Publication
(10) Pub. No.: US 2007/0067626 A1
(43) Pub. Date: Mar. 22, 2007

(54) Method and system for managing privacy policies

(75) Inventors: Alain Charles Louis Briancon, Poolesville, MD (US); Howard E. Goldberg, Wynnewood, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/322,687

(22) Filed: Dec. 30, 2005

Related U.S. Application Data
(60) Provisional application No. 60/717,979, filed on Sep. 16, 2005.

(51) Int. Cl. H04L 9/00

(52) U.S. Cl. 713/168

(57) ABSTRACT

The present invention is a method and system for managing privacy policies in ad-hoc networks by way of spatial and temporal landmarks. A privacy policy is associated with a geographic or temporal landmark, which is associated with a domain. An information system selects an appropriate privacy policy for a wireless transmit/receive unit (WTRU) associated with a landmark.

### CROSS REFERENCE TO RELATED APPLICATION

The present application claims the benefit of U.S. Provisional Application No. 60/717,979 filed Sep. 16, 2005, which is incorporated herein by reference as if fully set forth.

### FIELD OF INVENTION

The present invention relates generally to privacy and security policies in wireless communication networks. More specifically, the present invention relates to managing privacy and security policies in wireless communication networks.

### BACKGROUND

As wireless communication technology continues to develop, it is expected that all digital computing, data storage and media storage devices will be equipped with wireless networking functionality. These wireless devices will become part of ad-hoc communication networks that form from the mere existence of communications-enabled devices in a certain geographical area. When this happens, current methods of managing security and privacy policies will become unworkable because these methods are typically based around a centralized server, or a fixed network infrastructure. These methods perform poorly when ad-hoc communication networks are formed by mobile devices.

Ad-hoc network architecture, also called mesh networks or wireless mesh networks, are decentralized, relatively inexpensive, and very reliable and resilient, as each node only transmits as far as the next node. Nodes act as repeaters that transmit data from nearby nodes to peers that are too far away to reach, resulting in a network that can span large distances, especially over rough or difficult terrain. Mesh networks are also extremely reliable, as each node is connected to several other nodes. If one node drops out of the network, due to hardware failure, for example, neighboring nodes are used as an alternative route. Extra capacity can be installed by simply adding more nodes. Mesh networks may involve either fixed or mobile devices.

Ad-hoc network architecture uses data transmission protocols that are similar to Internet Protocol (IP), which is used to transmit packets around the wired Internet. Data will be routed from one device to another until the data reaches its destination. Dynamic routing capabilities included in each device facilitate this. To implement dynamic routing capabilities, each device may communicate its routing information to every device it connects with. Each device then determines what to do with the data it receives—either pass it on to the next device or keep it.

In a traditional wireless network where laptops connect to a single access point, for example, a fixed amount of bandwidth is shared by all of the users. As more laptops are connected, less bandwidth is available for each user. In mesh and adaptive radio networks, devices will only connect with other devices that are in a predetermined range. The advantage is that, like a natural load balancing system, as more devices join the network more bandwidth becomes available, provided that the number of hops in the average communications path is kept low. To prevent increased hop count from counteracting the advantages of multiple devices, one common type of architecture for a mobile mesh network includes multiple fixed base stations with “cut through” high-bandwidth terrestrial links that provide gateways to services, wired parts of the Internet, and other fixed base stations.

What is missing from the prior art is a simple way for privacy policies to be deployed over a wide range of geographic domains in an ad-hoc or mesh network infrastructure. Therefore, there is a need for managing privacy policies across both stationary wired and wireless network and mobile ad-hoc networks.

### SUMMARY

The present invention is a method and system for managing privacy policies in ad-hoc networks by way of spatial and temporal landmarks. A privacy policy is associated with a geographic or temporal landmark, which is associated with a domain. An information system selects an appropriate privacy policy for a wireless transmit/receive unit (WTRU) associated with a landmark.

### BRIEF DESCRIPTION OF THE DRAWINGS

A more thorough understanding of the present invention may be had from the following detailed description, to be read in conjunction with the following drawing figures, wherein:

FIG. 1 is an illustration of a system for managing privacy policies wherein a landmark associated with a geographic domain is used;

FIG. 2 is an flow chart of a method for managing privacy policies in accordance with the present invention;

FIG. 3 is an illustration of a system for managing privacy policies wherein a plurality of mobile devices co-exist within the same geographic domain;

FIG. 4 is an illustration of a system for managing privacy policies wherein a geographic domain and landmark is defined around a WTRU; and

FIG. 5 is an illustration of a system for managing privacy policies wherein ad-hoc network infrastructure is utilized.

### DETAILED DESCRIPTION OF THE PREFERRED EMBODIMENTS

The present invention will be described in more detail with reference to the drawing figures wherein like numerals indicate like elements.

As referred to herein, a wireless transmit/receive unit (WTRU) includes, but is not limited to, a cell phone, pager, laptop, user equipment (UE), mobile station (MS), a fixed or mobile subscriber unit, or any other device capable of operating in a wireless communication system. As referred to herein, the term ‘access point’ includes but is not limited to a base station, a Node-B, a site controller, or any other type of interfacing device in a wireless environment. As used herein, the term ‘privacy policy’ includes, but is not limited to, information and settings relating to file access, including what devices can access files, store files, delete files and other information on a given device, security settings, communication settings, input/output configurations, cryptography keys, passwords, file access restrictions, and other privacy and security information typically used to control access to or prevent unauthorized access of wireless devices. The term ‘landmark’ as used herein refers to the identity of a given geographic domain. A WTRU may operate in the given geographic domain, in which case the WTRU is associated with the landmark and the geographic domain.

The present invention does not address the generation of privacy policies. Rather, the present invention is a method and system for managing privacy policies in ad-hoc networks. In contrast to prior art privacy policy management, the present invention uses landmarks to identify geographic domains. The landmark may designate a mobile device (such as “Howard's Phone”), a beacon (such as “Cafeteria on 3^{rd} Floor”), an access point (such as “Alain's Access Point”), or a geographic domain (such as “Rocco's Sushi Grill” or “Liberty Bell Plaza”). An information system is utilized for managing the assignment of privacy policies to WTRUs operating within various geographic domains. Organizing the privacy policies stored and managed by the information system is essential as potentially thousands of such domains could be managed simultaneously. The information system may be centralized or distributed, but must be accessible to all of the fixed and mobile nodes of the network, either directly or indirectly, for receiving privacy policy management information.

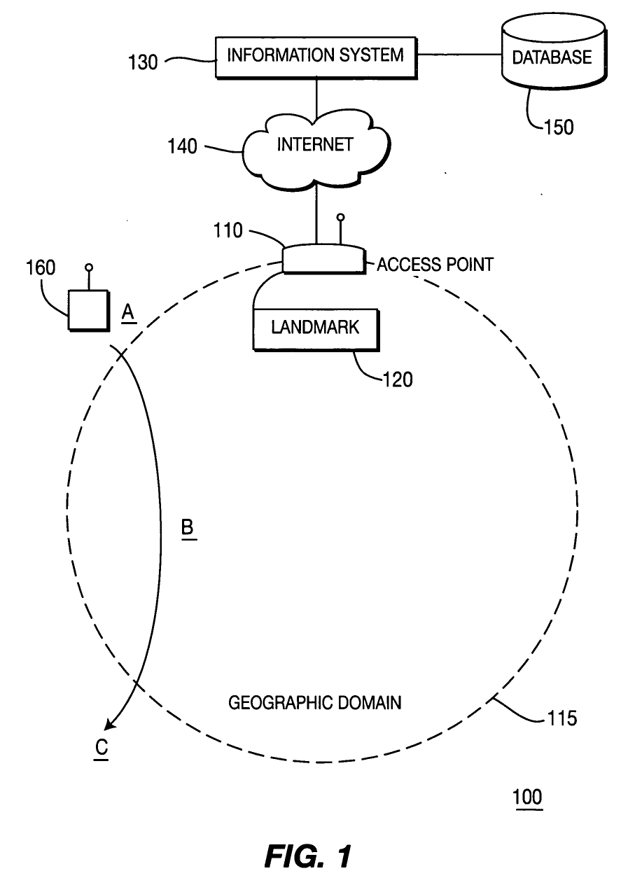

Referring to FIG. 1, a system 100 for managing privacy policies in accordance with a first embodiment of the present invention is shown. The system 100 comprises a wireless access point (AP) 110 for providing WTRU 160 access to the Internet 140 and other hard wired networks (not shown). An information system 130 manages the selection and implementation of privacy policies. The privacy policies, related information, and the landmarks the policies are associated with are stored in a database 150. It should be understood by one skilled in the art that the information system 130 and the database 150 may be remotely located, either separately or in combination. Alternatively, the functionality of the information system and the database 150 may be dispersed amongst a variety of local devices, communicating with each other via the Internet or ad-hoc networks.

In this embodiment, the geographic domain 115 in which the AP is located is fixed and stationary, and is designated by a landmark 120. For example, the geographic domain 115 may be your office, in which case the landmark 120 is ‘OFFICE’. Alternatively, the geographic domain 115 may be your boss's office, in which case the landmark 120 is ‘PRESIDENT'S OFFICE’. Alternatively, a larger scale geographic domain could be your place of employment (i.e. the entire office building or business campus), in which case the landmark 120 is ‘WORK’. Where the landmark 120 is ‘OFFICE’, the geographic domain 115 would encompass the three dimensional spatial confines of your office. In this embodiment, where the landmark 120 is associated with an access point 110, the landmark 120 does not limit the coverage area of the access point 110 to the physical confines of the office. However, when a WTRU communicates using the AP 110, the WTRU may be subject to any privacy policies associated with the landmark 120 even though the WTRU may not be within the geographic domain 115 associated with the landmark 120.

To illustrate how the present invention manages privacy policies, WTRU 160 at position A is located outside of the geographic domain 115 designated by landmark 120. As WTRU 160 moves to position B inside the geographic domain 115 (you enter your office with your mobile phone in your briefcase, for example), WTRU 160 begins communicating with AP 110. AP 110 contacts information system 130 which selects the appropriate privacy policy from database 150, based on the landmark 120. Alternatively, WTRU 160 contacts information system 130, provides information system 130 with landmark 120 information, and then information system 130 selects the appropriate privacy policy.

The information system 130 transmits the selected privacy policy to the WTRU 160 located at position B. While WTRU 160 is within the geographic domain 115, the WTRU 160 must maintain the requirements of the selected privacy policy in order to wirelessly communicate with AP 110. When WTRU 160 leaves the geographic domain 115 (position C) and ceases communications with AP 110, the privacy policy implemented by WTRU 160 may change, but in any event is no longer required to be the privacy policy required by landmark 120.

Additionally, information concerning the equipment operating inside of a given geographic domain, such as a WTRU, may also be used to select an appropriate privacy policy. Serial numbers of wireless devices, system identifiers, registration numbers, user IDs, and other similar pieces of data may be transmitted to the information system managing privacy policies in order to achieve the goals of the privacy policy.

A determination of whether a WTRU is located within geographic domain 115 can be made using various means. In a geographic domain where no access point is present, sensor based detection may be quickly and easily implemented in order to sense the physical presence of a WTRU within the geographic domain. Other means for determining whether a device is located within a particular domain, such as location information derived from the primary function of the device (in a case of a wireless device), location information derived from an ancillary function of the device (such as local BlueTooth connection or wireless Universal Serial Bus (USB) port for a camera device, a Wi-Fi connection for a PC), and mapping of wired Ethernet topology for a wired Personal Computer (PC) connected to an RJ-45 jack in the wall, for example, may also be used.

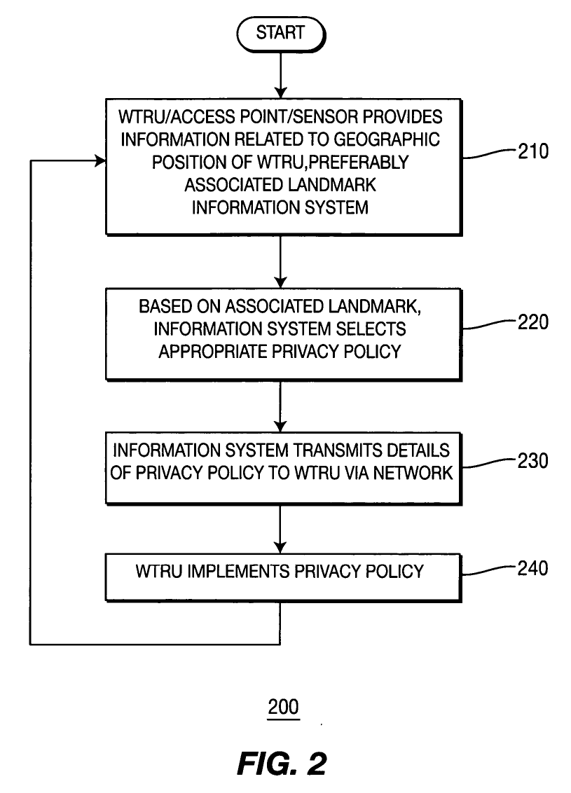

Referring to FIG. 2, a method 200 for managing privacy policies in accordance with the present invention is shown. A wireless transmit/receive unit provides information related to its geographic position to an information system (step 210). This information may simply be the landmark associated with the geographic domain in which the WTRU is currently located. Alternatively, an access point may inform the IS that a WTRU is located within the domain, and the access point provides the landmark information to the IS. Additionally, the WTRU or access point may provide information regarding the WTRU. Next, the information system selects an appropriate security policy based on the landmark information provided by the WTRU or the access point, and any WTRU related information, (step 220). The information system transmits information regarding the selected privacy policy to the WTRU (step 230). The WTRU then implements the selected privacy policy to maintain communications with the access point in the geographic domain or other communication enabled devices within the domain (step 240).

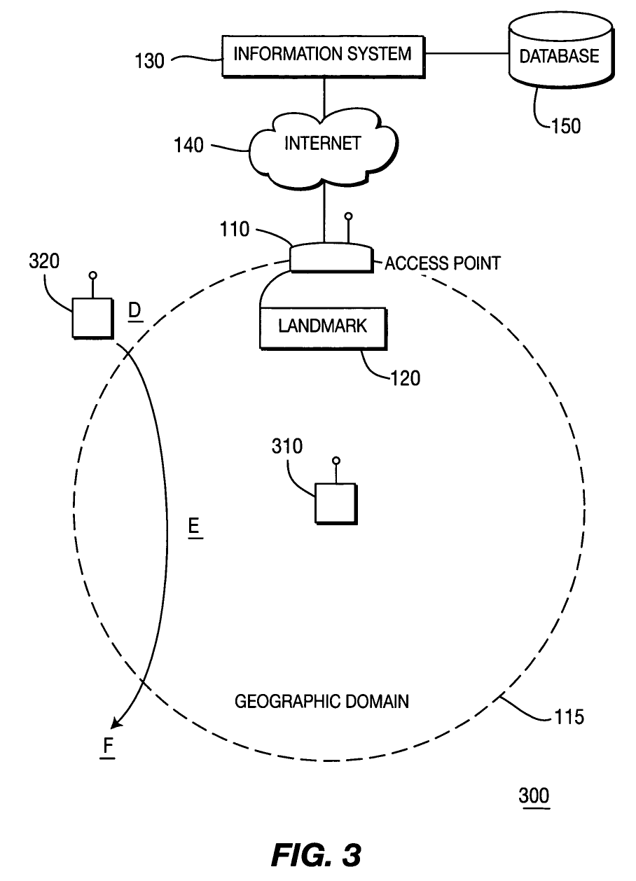

Referring to FIG. 3, in an alternative embodiment of the present invention, a system 300 for managing privacy policies where multiple WTRUs co-exist within the same geographic domain is shown. The co-existence of WTRUs in a geographic domain 115 is the impetus to alter the privacy policy. To illustrate, WTRU 310 belongs to a given organization, and when WTRU 310 is associated with landmark 120 the information system 130 will set the privacy policy accordingly for those conditions. When foreign WTRU 320 moves from position D outside of the geographic domain 115 associated with landmark 120 to position E within the geographic domain 115 associated with landmark 120, the information system will consider the types and identities of the WTRUs 310, 320 in determining whether privacy policies for either of the WTRUs should be modified. Where foreign WTRU 320 is in fact a device that is not associated with the given organization, or is not recognized as being associated with the organization, the information system 130 may alter the privacy policy for both WTRUs. The privacy policy of the WTRUs 310, 320 may be heightened such that a more secure operating environment is created, preventing the foreign WTRU 320 from accessing organization files, or transmitting files to WTRU 310 or various other components of the organizations computer infrastructure. It should be understood that the goal of managing privacy policies is generally to provide more secure communications across the wireless communication system, and there are a variety of ways to achieve this goal that are apparent to those skilled in the art.

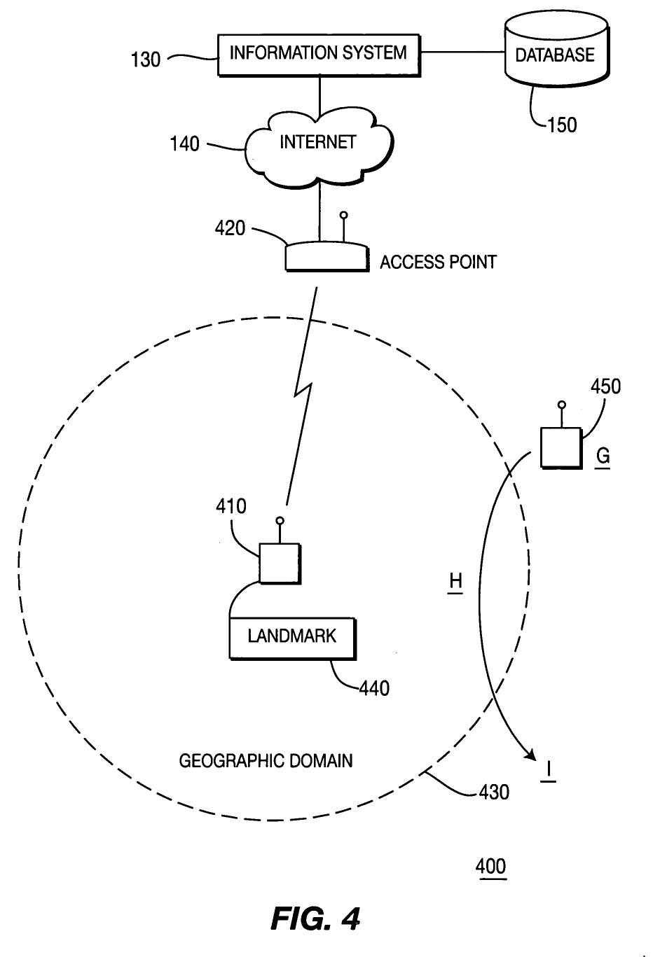

Referring to FIG. 4, in another embodiment of the present invention, a system 400 for managing privacy policies where a landmark is associated with a geographic domain surrounding a mobile WTRU is shown. In this embodiment, WTRU 410 is a mobile device, and purely for example, a mobile telephone. WTRU 410 is within range of access point 420, which, purely for simplicity of description, does not have an associated landmark, geographic domain, or associated privacy policy. Access point 420 may be an Internet gateway for ad-hoc networks of the type discussed in the background of the present application, or an access point in a wireless metropolitan area network (WMAN), for example.

The geographic domain 430 surrounding WTRU 410 is associated with landmark 440, which may be, for example, ‘123-456-7890’, i.e. the phone number of the WTRU 410. A second WTRU 450 located at position G is not within the geographic domain 430 of WTRU 410. When WTRU 450 is positioned within the geographic domain 430 of WTRU 410 at position H, an appropriate privacy policy is selected by the information system 130. Similar to the embodiment described with reference to FIG. 1, when WTRU 450 moves out of the geographic domain 430 associated with WTRU 410 and landmark 440 to position I, the privacy policy associated with landmark 440 need not be implemented by WTRU 450. It should be understood that in an ad-hoc network the majority of interactions between WTRUs will occur in the manner described in this embodiment. In other words, in an ad-hoc network, WTRUs greatly outnumber access points, and thus the management of privacy policies will most likely occur around mobile geographic domains associated with WTRUs.

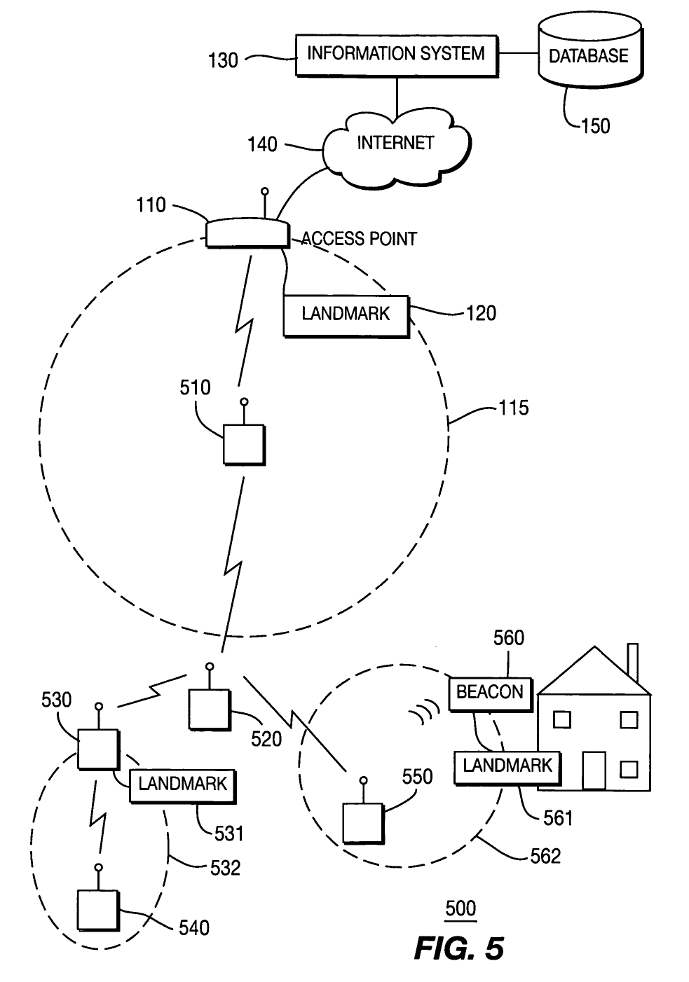

Referring to FIG. 5, in another embodiment of the present invention, a system 500 for managing privacy policies in an ad-hoc network is shown. WTRUs 510, 520, 530, 540, and 550 are all part of an ad-hoc wireless communication network. Access to the Internet 140 and information system 130 occur via access point 110. For example, WTRU 540 receives data packets from the Internet 140 through access point 110, WTRU 510, WTRU 520, and WTRU 530. WTRU 540 is within the geographic domain 532 of WTRU 530, and is associated with landmark 531. Information system 130 selects an appropriate privacy policy for WTRU 540 based on the associated landmark 531. Similarly, WTRU 550 is within the geographic domain 562 of beacon 560, and is associated with landmark 561. Landmark 561 is a house, and has no access point to the information system 130. However, WTRU 550 receives landmark 561 information from beacon 560, and communicates with information system 130 via the ad-hoc network to receive the appropriate privacy policy for the geographic domain 562 based on associated landmark 561.

In an alternative embodiment, the IS controlling the management of privacy policies may be incorporated into a WTRU. Alternatively, many WTRUs may carry out the management of privacy policies in accordance with the present invention thereby stretching the management, processing, and storage requirements across many handsets.

In an alternative embodiment, a WTRU may operate in multiple domains and be associated with multiple landmarks, and may thus identify its geographic or temporal location using multiple landmarks. For example, an office may have a beacon that emits landmark information. The location of this office may be in a secure building, such as a police station, where the entire building is a geographic domain identified by a separate landmark. Accordingly, a WTRU carried into the office is currently within two geographic domains designated by landmarks ‘Office’ and ‘Police Station’. The WTRU would then be subject to both the privacy policy associated with the landmark ‘Office’ as well as the privacy policy associated with the landmark ‘Police Station’.

In this case, the information system contains a clearinghouse for resolving conflicting privacy policies. Priorities for privacy policies may be set and utilized by the information system for determining which privacy policy's settings are to be implemented by the WTRU. Alternatively, the most secure privacy policy settings may be utilized so that no undesired access occurs. The clearing house can be located at the information system or remotely located as in federated web systems.

In another embodiment of the present invention, the landmark is not an identifier of a geographic domain, but is instead an identifier of a temporal domain. In this manner, privacy policies may be managed not only based on geographic positioning of a WTRU, but also by the time at which a WTRU is positioned in a given geographic domain. For example, a movie theater may have a temporal landmark indicating the window of time during which the premier feature will be shown. WTRUs present within the movie theatre will associate with the temporal landmark and a privacy policy will be selected that, for example, requires all audible ringers to be silenced. For example, not only may all WTRUs be instructed to silence their ringers, but all calls may be forwarded directly to voice mail, or alternatively, only calls from a select list of emergency contacts may be allowed through to the WTRU.

The combination of geographic landmarks and temporal landmarks provides a powerful way to manage privacy policies across mobile, ad-hoc communication networks. It should be understood by one skilled in the art that the present invention may be implemented in a variety of wireless communication networks. For example, privacy and security policies are widely used in IEEE 802.x networks, BlueTooth communication networks, Ethernet based networks, 3GPP networks, and the like.

Although the present invention has been described with reference to the preferred embodiments, those skilled in the art will recognize that changes may be made in form and detail without departing from the scope of the invention.

What is claimed is:

1. A method of managing privacy policies in a wireless communication system, the method comprising:
detecting the presence of a wireless transmit/receive unit (WTRU) within a geographic domain designated by a landmark;
selecting an appropriate privacy policy based on the landmark and the detected WTRU;
transmitting the selected privacy policy to the detected WTRU; and
implementing at the WTRU the transmitted privacy policy while the WTRU is associated with the landmark.

2. The method of claim 1, wherein the WTRU is associated with an access point designated by the landmark.

3. The method of claim 2, wherein the selection of an appropriate privacy policy is further based upon the identity of the WTRU.

4. The method of claim 1, wherein all WTRUs currently associated with the landmark are considered when determining an appropriate privacy policy for a given WTRU.

5. The method of claim 1, wherein an information system selects an appropriate privacy policy.

6. The method of claim 5, wherein the information system is remotely located and connected to the WTRU via the Internet.

7. The method of claim 5, wherein the functions performed by the information system are distributed among a variety of communication devices.

8. The method of claim 7, wherein the variety of communication devices include wireless communication devices such as WTRUs.

9. The method of claim 1, wherein several privacy policies are transmitted to the WTRU and a user of the WTRU selects an appropriate privacy policy for implementation.

10. The method of claim 1, wherein the landmark is associated with a geographic domain surrounding another WTRU.

11. The method of claim 1, wherein the communication system is an ad-hoc wireless communication system.

12. The method of claim 1, wherein a privacy policy includes at least one of a file access permission, security settings, communication settings, input/output configurations, cryptography keys, passwords, and file access restrictions.

13. A method of managing privacy policies in wireless communication systems, the method comprising:
detecting the presence of a wireless transmit/receive unit (WTRU) within a temporal domain designated by a landmark;
selecting an appropriate privacy policy based on the landmark and the detected WTRU;
transmitting the selected privacy policy to the detected WTRU; and
implementing at the WTRU the transmitted privacy policy while the WTRU is associated with the landmark.

14. The method of claim 13, wherein the WTRU is associated with an access point designated by the landmark.

15. The method of claim 14, wherein the selection of an appropriate privacy policy is further based upon the identity of the WTRU.

16. The method of claim 13, wherein all WTRUs currently associated with the landmark are considered when determining an appropriate privacy policy for a given WTRU.

17. The method of claim 13, wherein an information system selects an appropriate privacy policy.

18. The method of claim 17, wherein the information system is remotely located and connected to the WTRU via the internet.

19. The method of claim 17, wherein the functions performed by the information system are distributed among a variety of communication devices.

20. The method of claim 19, wherein the variety of communication devices include wireless communication devices such as WTRUs.

21. The method of claim 13, wherein several privacy policies are transmitted to the WTRU and a user of the WTRU selects an appropriate privacy policy for implementation.

22. The method of claim 13, wherein the landmark is associated with a geographic domain surrounding another WTRU.

23. The method of claim 13, wherein the communication system is an ad-hoc wireless communication system.

24. The method of claim 13, wherein a privacy policy includes at least one of a file access permission, security settings, communication settings, input/output configurations, cryptography keys, passwords, and file access restrictions.

25. A wireless communication system for managing privacy policies among a plurality of wireless transmit/receive units (WTRUs) comprising:
at least one geographic domain, wherein the geographic domain is associated with a landmark;
at least one WTRU located within at least one geographic domain, the at least one WTRU being associated with the landmark designating the geographic domain in which the WTRU is located; and
an information system for determining an appropriate security policy for the at least one WTRU associated with the landmark.

26. The system of claim 25, wherein the information system includes a database for storing privacy policy information.

27. The system of claim 25, wherein the at least one geographic domain is further associated with at least one access point.

28. The system of claim 25, wherein the information system selects an appropriate privacy policy based on the landmark associated with the at least one WTRU.

29. The system of claim 28, wherein at least two WTRUs are present in a geographic domain, and the information system selects an appropriate privacy policy for the at least two WTRUs based on the associated landmark and the at least two WTRUs.

30. The system of claim 25, wherein ad-hoc network architecture is utilized.

31. The system of claim 25, wherein the geographic domain further includes a temporal landmark.

32. The system of claim 25, wherein a privacy policy includes at least one of a file access permission, security settings, communication settings, input/output configurations, cryptography keys, passwords, and file access restrictions.
